(19) United States
(12) Patent Application Publication
(10) Pub. No.: US 2025/0165996 A1
(43) Pub. Date: May 22, 2025

(54) METHOD FOR PROVIDING BOX OFFICE PREDICTION RESULTS THROUGH ANALYSIS OF TEXT CONTENT AND APPARATUS THEREFOR

(71) Applicant: CJ OliveNetworks Co., Ltd., Seoul (KR)

(72) Inventors: Byung Hak KIM, Seoul (KR); Se Un Park, Seoul (KR); Kyong Mook Lim, Seoul (KR); Jung Jun Kim, Seoul (KR); Dong Il Shin, Seoul (KR); Ye Eun Chun, Seoul (KR); Chan Hyuk Choi, Seoul (KR); Emma Bergqvist, Seoul (KR); Gyu Won Park, Seoul (KR)

(21) Appl. No.: 18/396,247

(22) Filed: Dec. 26, 2023

(30) Foreign Application Priority Data
Nov. 22, 2023 (KR) 10-2023-0163800

(51) Int. Cl. G06Q 30/0202; G06F 40/30

(52) U.S. Cl. CPC G06Q 30/0202; G06F 40/30

(57) ABSTRACT

The present disclosure relates to a method of providing a box office prediction result through an analysis of text content and an apparatus therefor, and more particularly, to a method of providing a box office prediction result of content through analyzing text input in various languages including Korean and English.

### BACKGROUND OF THE INVENTION

### Field of the Invention

The present disclosure relates to a method of providing a box office prediction result through an analysis of text content and an apparatus therefor, and more particularly, to a method of providing a box office prediction result of content through analyzing text input in various languages including Korean and English.

### Background of the Related Art

Content products such as movies, dramas, webnovels, and webtoons are becoming box office hits. Meanwhile, in the case of those content products, it may be difficult for an operator providing content services to predict in advance how successful a new content product will be, and therefore, the operator has generally been providing a certain number of episodes for free, looking at consumers' reactions, and signing a formal contract with the writer.

However, such a type of content product contract method also does not guarantee the success of the content product, and if a contract is made without objective grounds in a situation where it is difficult to predict whether the content product will be a hit or not, the content product may be selected at the operator's discretion, and there may also be side effects, such as the possibility that only works by famous writers with guaranteed box office success will continue to be selected, so it is necessary to analyze content products more objectively and then predict the resulting box office success.

In addition, in the case of movies or dramas, the production environment itself is completely different from web novels or webtoons, and thus it is more difficult to provide an initial episode first and predict whether or not it will be a box office hit, and as a result, even in movies and dramas, there is a very high demand for a means to objectively analyze and predict box office success before full-scale production. In recent years, in movies and dramas, through the Green Light Committee (GLC), multiple individuals review the work and analyze various box office elements qualitatively or quantitatively to indirectly derive and add up the box office performance. However, personal bias of GLC members—for example, reviewers who like romance—or systematic bias—for example, scripts by famous writers with many successful works—are problems that cannot be solved in the current GLC system.

An objective of the present disclosure is to solve current difficulties in decision-making or pre-production of content production, and establish a scientific box office analysis and inference system as well as a debut platform for fledgling writers where new writers' works can be evaluated objectively and compete fairly and succeed. Therefore, the present disclosure relates to a method and apparatus that objectively and scientifically analyzes the information of content, analyzes metadata included in the content to derive factors related to box office success, extracts the derived factors qualitatively and quantitatively to predict box office success, and provides a box office prediction result through the analysis of text content that is qualitatively evaluated by the answers to the preset questions, highly correlated with box office success, along with the quantitative measures or scores of each evaluation or categories of the potential target viewers, and that is qualitatively displayed using a graph form to allow a user to visually check the prediction result.

### CITATION LIST

### Patent Literature

Korean Patent Registration No. 10-2296154 (registered on Aug. 25, 2021)

### SUMMARY OF THE INVENTION

An aspect of the present disclosure is to analyze text content input in various languages, including Korean and English, and provide a user with a box office prediction result that is helpful in producing image content such as a movie, a drama, and a webtoon.

Furthermore, an aspect of the present disclosure is to predict the success or failure of a script, a scenario, and a proposal for content including a movie, a drama, a novel, and a webtoon, and provide a prediction result to the user.

In addition, an aspect of the present disclosure is to make predictions using an original script or a full shooting script for content including a movie, a drama, a novel, and a webtoon, as well as an early partial script—e.g., episode 1 or episodes 1 to 4 of drama scripts—as input available at an actual initial investment/production decision stage or proposal data centered on composition or plot as input.

Moreover, an aspect of the present disclosure is to generate an analysis result through the analysis of text content based on content information included in the text content.

Besides, an aspect of the present disclosure is to subdivide the analysis result to derive box office factors for text content in connection with box office elements.

Furthermore, an aspect of the present disclosure is to generate a box office prediction result for text content based on the analysis result and the derived box office factors.

In addition, an aspect of the present disclosure is to easily receive text content through copying and pasting information on the text content or dragging and dropping a file corresponding to the text content.

Moreover, an aspect of the present disclosure is to generate an analysis result for text content through generating a summary of the text content and analyzing metadata information, and provide the generated analysis result to the user.

Besides, an aspect of the present disclosure is to predict box office performance for text content in advance through generating an image related to text content, deriving a box office prediction index, generating an answer to a content-related question, and simulating a user's box office index.

The present disclosure is contrived to solve the foregoing problems, and there is provided a method of analyzing text content to provide a box office prediction result, the method including receiving text content from a user; generating, based on content information included in the text content, an analysis result through the analysis of the text content; generating, based on the analysis result, a box office prediction result for the text content; and providing the box office prediction result to the user.

Furthermore, according to the method, the text content may include at least one of a script, a scenario, and a proposal for content including a movie, a drama, a novel, and a webtoon.

Furthermore, according to the method, the receiving of the text content may include receiving information on the text content through direct typing from the user; or receiving information on the text content through a copy-and-paste operation; or receiving a file corresponding to the text content using a drag-and-drop method.

Furthermore, according to the method, the file corresponding to the text content may be a text-based file with an extension of any one of txt, rtf, doc, docx, htm, html, xls, xlsx, json, and pdf.

Furthermore, according to the method, the generating of the analysis result may include generating a summary of content information included in the received text content; and analyzing metadata information on the text content to generate a metadata analysis result.

Furthermore, according to the method, the metadata information may include at least one of person information, genre information, location information, or conversation information between people included in information on the text content, wherein the metadata analysis result includes at least one of a genre characteristic map, a number of scenes, a number of characters, a number of locations, a number of conversations, a number of scenes and lines for each main character, estimated cost of production, or a character relationship between main characters for the text content.

Furthermore, according to the method, the generating of the box office prediction result may include predicting box office performance of the text content based on the content analysis, the summary and the metadata analysis result; and generating a box office prediction result that qualitatively represents a box office index according to the prediction.

Furthermore, according to the method, when the text content is a drama, the box office performance may include an expected viewership rating or grade of the drama, the number of views or votes/likes in digital formats, the number of positive news and the number of negative news and their combinations, such as subtraction, social media responses including evaluative phrases or sentences or the emoticons such as a smiling face a thumbs-up, and a combination of all of these, and when the text content is a movie, the box office performance may include a return on investment (ROI) and similar metrics as in a drama.

Furthermore, according to the method, the generating of the box office prediction result may include qualitatively displaying the box office index using a graph form for preset box office elements to generate the box office prediction result.

Furthermore, according to the method, the method may further include, subsequent to generating the box office prediction result, generating a first answer corresponding to a preset first question based on the box office prediction result and information on the text content; and generating a second answer corresponding to a second question received from the user.

On the other hand, an apparatus of analyzing text content to provide a box office prediction result according to another embodiment of the present disclosure may include a content receiving unit that receives text content; analysis result generation unit that generates an analysis result for text content; a prediction result generation unit that generates a box office prediction result for text content; and a result providing unit that provides a box office prediction result to a user.

Furthermore, according to the apparatus, the content receiving unit may receive text content from a user, wherein the analysis result generation unit generates, based on content information included in the text content, an analysis result through the analysis of the text content, and the prediction result generation unit generates, based on the analysis result, a box office prediction result for the text content, and the result providing unit provides the box office prediction result to the user.

Furthermore, the apparatus may further include a question-and-answer unit that generates, subsequent to generating the box office prediction result, an answer corresponding to a preset question, or an answer corresponding to a user's question different from the preset question.

On the other hand, according to a system according to still another embodiment of the present disclosure, the system may include a memory in which at least one program is recorded; and a processor that executes the program, and the program may include receiving text content from a user; generating, based on content information included in the text content, an analysis result through the analysis of the text content; generating, based on the analysis result, a box office prediction result for the text content; and providing the box office prediction result to the user.

According to the present disclosure, text content input in various languages, including Korean and English may be analyzed to provide a user with a box office prediction result that is helpful in producing image content such as movies, dramas, and webtoons.

Furthermore, according to the present disclosure, a script, a scenario, a proposal, and the like for content including a movie, a drama, a novel, and a webtoon may be received as input, thereby having an effect capable of analyzing and predicting success factors of a work before producing a video or image.

In addition, according to the present disclosure, an analysis result may be generated through the analysis of text content based on content information included in the text content.

Moreover, according to the present disclosure, a box office prediction result for text content may be generated based on the analysis result.

Besides, according to the present disclosure, functions for enhancing user convenience, such as copying and pasting text and dragging and dropping a file, may be provided, thereby having an effect capable of allowing the user to perform a task without any burden in the process of entering the information of text content.

Furthermore, according to the present disclosure, an analysis result for text content may be generated through generating a summary of the text content and analyzing metadata information to provide the generated analysis result to the user.

In addition, according to the present disclosure, box office performance for text content may be predicted in advance through generating an image related to text content, deriving a box office prediction index, generating an answer to a content-related question, and simulating a user's box office index.

In addition, according to the present disclosure, technical idea described in the present disclosure may be applied to any text-based content such as radio dramas, plays, novels, musicals, and the like, in addition to movies, dramas, novels, and webtoons.

On the other hand, the effects of the present disclosure may not be limited to the above-mentioned effects, and other technical effects which are not mentioned herein will be clearly understood by those skilled in the art from the description below.

### BRIEF DESCRIPTION OF THE DRAWINGS

FIG. 1 is a flowchart showing steps of a method of providing a box office prediction result through the analysis of text content according to the present disclosure.

FIG. 2 is a flowchart showing steps of a method of generating an analysis result according to the present disclosure.

FIG. 3 is a flowchart showing steps of a method of generating a box office prediction result according to the present disclosure.

FIG. 4 is a flowchart showing steps of a method of generating an answer to a question according to the present disclosure.

FIG. 5 is a diagram showing an example of an interface for dragging and dropping a text content file.

FIG. 6 is a diagram showing an example of a summary of text content.

FIG. 7 is a diagram showing an example of a metadata analysis result.

FIG. 8 is a diagram showing an example of an interface for selecting a viewership rating or grade in predicting the box office performance of a drama.

FIG. 9 is a diagram showing an example of a box office index graph for text content.

FIG. 10 is a diagram showing an example of a cartoon concept image generated for text content.

FIG. 11 is a diagram showing an example of a realistic image generated for text content.

FIG. 12 is a diagram showing an example of natural language questions about text content and answers thereto.

FIG. 13 is a diagram showing an example of a radial graph of an analysis result for text content.

FIG. 14 is a diagram showing an example of a search result for works similar to text content.

FIG. 15 is a diagram showing an example of scores assigned to questions about text content.

FIG. 16 shows detailed configurations of an apparatus that provides a box office prediction result through the analysis of text content according to the present disclosure.

### DESCRIPTION OF SYMBOLS

100: Box office prediction result providing apparatus
110: Content receiving unit
120: Analysis result generation unit
130: Prediction result generation unit
140: Result providing unit
150: Question-and-answer unit
160: Calculation unit
170: Storage unit

### DETAILED DESCRIPTION OF THE PREFERRED EMBODIMENT

The details of the objects and technical configurations of the present disclosure and operational effects thereof will be more clearly understood from the following detailed description based on the accompanying drawings appended hereto. Hereinafter, embodiments according to the present disclosure will be described in detail with reference to the accompanying drawings.

Embodiments disclosed herein should not be interpreted as limiting or used to limit the scope of the present disclosure. It is apparent for those skilled in the art that a description including embodiments herein has various applications. Therefore, any embodiments described in the detailed description of the present disclosure are illustrative for better understanding of the present disclosure and are not intended to limit the scope of the present disclosure to the embodiments.

Functional blocks illustrated in the drawings and described hereunder are only examples of possible implementations. In other implementations, other functional blocks may be used without departing from the concept and scope of the detailed description. Furthermore, one or more functional blocks of the present disclosure are illustrated as separate blocks, but one or more of the functional blocks of the present disclosure may be a combination of various hardware and software elements that execute the same function.

In addition, an expression that some elements are “included” is an expression of an “open type”, and the expression simply denotes that the corresponding elements are present, but should not be construed as excluding additional elements.

Moreover, in case where it is mentioned that one element is “connected” or “coupled” to the other element, it should be understood that one element may be directly connected to the other element, but another element may be present therebetween.

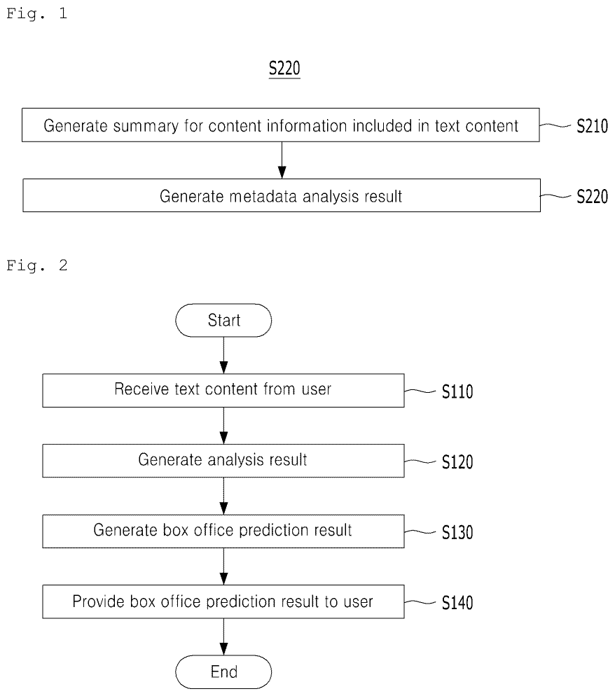

FIG. 1 is a flowchart showing steps of a method of providing a box office prediction result through the analysis of text content according to the present disclosure.

Referring to FIG. 1, a method of providing a box office prediction result through the analysis of text content according to the present disclosure may first include receiving text content from a user (S110).

Here, the text content may include at least one of a script, a scenario, and a proposal for content including a movie, a drama, novel, and a webtoon. Furthermore, a script, a scenario, and a proposal may be written in various languages, including Korean or English.

Next, based on content information included in the text content, an analysis result may be generated through the analysis of the text content (S120). This step may be carried out based on basic unit configurations that can be acquired from the text content, for example, a plurality of words, sentences, and punctuation marks, and analysis may be made on the genre, plot, characters, dynamics between characters, or locations of the text content based on those structures.

Next, based on the analysis result, a box office prediction result for the text content may be generated (S130). In this step, based on the analysis in step S120, a box office prediction result of the text content may be provided to the user as a numeric (value), wherein the numeric may vary depending on the type of content that is subject to analysis. For example, in the case of text content for drama content, a viewership rating prediction value may be provided to the user, and in the case of text content for movie content, a return on investment (ROI) prediction value may be provided to the user. In this way, the generation of the box office prediction result may vary depending on the type of content that is subject to analysis.

Finally, the previously generated box office prediction result may be provided to the user, and the box office prediction result provided at this time may be provided through an interface in a form that can be intuitively understood by the user (S140).

Meanwhile, in the previous description, it has been described that the user can receive text content in step S110, wherein the step S110 may be implemented such that information on the text content can be received from the user in various manners. For example, the step S110 may be implemented to receive text content through direct typing from the user, or may be implemented to allow the user to input information on the text content through a copy-and-paste operation.

Alternatively, the step S110 may be implemented to receive a file corresponding to the text content from the user using a-drag-and-drop method. Here, the file corresponding to the text content may include a text-based file with an extension of any one of txt, rtf, doc, docx, htm, html, json, xls, xlsx and pdf. For example, when the file corresponding to the text content has an extension such as docx, doc, htm, html, xlsx, or the like, the file may be internally converted into text. Furthermore, when the file corresponding to the text content is a pdf or image file, the text may be extracted and converted into text through optical character recognition (OCR).

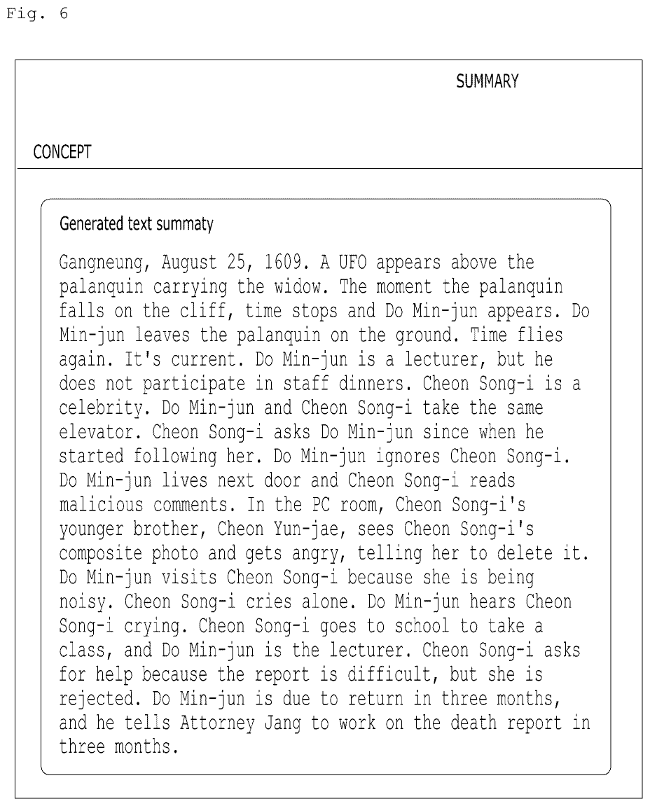

For reference, FIG. 5 is a diagram showing an example of an interface for supporting the user to input a text content file using a drag-and-drop method. The user may input a file corresponding to text content within a designated area on the interface using a drag-and-drop method, thereby having an effect of allowing the user to easily enter information of text content without direct typing information of the file through the interface of inputting the file using the drag-and-drop method.

FIG. 2 is a flowchart showing steps of a method of generating an analysis result according to the present disclosure.

Referring to FIG. 2, a method of providing an analysis result in the method of generating a box office prediction result through the analysis of text content according to the present disclosure may first include generating a summary of content information included in the received text content (S210). The present disclosure may be implemented to first generate a summary from text content when the text content containing a large amount of words and sentences has been input, thereby greatly reducing the amount of text content that is subject to analysis so as to increase the efficiency of calculations required for analysis. This step may preferably be implemented to generate a summary with a word count ranging from 18 to 10% of a total number of words included in the text content input by the user.

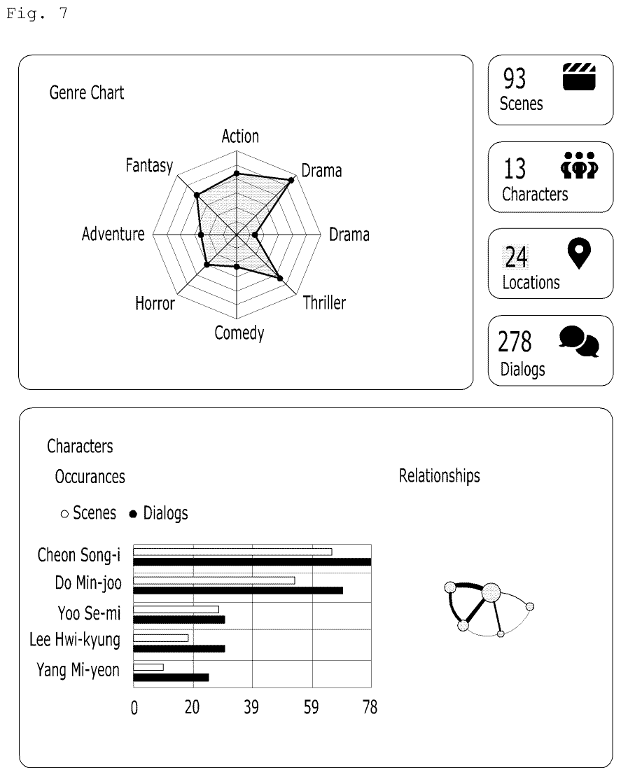

FIG. 6 is a diagram showing an example of a summary of text content. When arbitrary text content input by the user is a drama script, the information of the drama script may be briefly summarized to generate a summary as shown in FIG. 6. For reference, in the above summary generation step, a characters' dialogue may be excluded to generate a summary that describes characters, locations, relationships between characters, and the like so that the relevant scene can be drawn just by reading the summary.

Next to step S210, metadata information on the text content may be analyzed to generate a metadata analysis result (S220).

Here, the metadata information may include at least one of person information, genre information, location information, or conversation information between people included in information on the text content.

In addition, the metadata analysis result generated in the step S220 may include at least one of a genre characteristic map, a number of scenes, a number of characters, a number of locations, a number of conversations, a number of scenes and lines for each main character, or a character relationship between main characters for the text content.

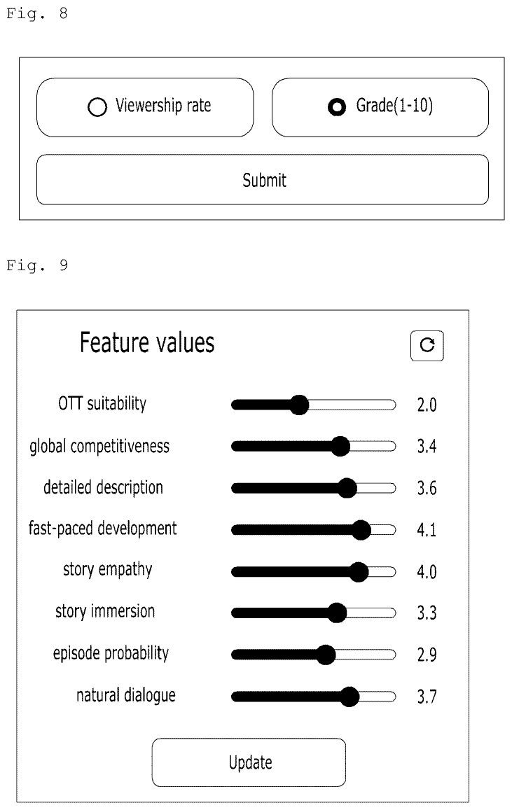

FIG. 7 is a diagram showing an example of a metadata analysis result. Referring to FIG. 7, the metadata analysis result may include a genre characteristic map, and scores may be assigned to respective representative genres according to the characteristics of the input text content (the representative genres are predetermined), and the assigned scores may be connected to one another to display a genre characteristic map in the form of a radial graph. Through this, the user may look at the radial graph to intuitively identify which genre is the genre characteristic of the content closest to. When referring to the drawing, it can be seen that the currently input text content has relatively strong drama, action, and thriller characteristics.

In addition, the metadata analysis result may include a number of characters, a number of scenes, a number of locations, or a number of characters' conversations that appear in the text content. Those analysis result values may be calculated based on words that are tokenized and distinguished in a step of generating the summary, and this step may be preferably implemented to identify, by a pre-trained artificial intelligence algorithm, distinguished scenes, distinguished characters, locations where scenes take place, and a number of conversations between characters from the text content, thereby calculating analysis result values as shown in the drawing.

Meanwhile, the metadata analysis result may represent a number of scenes and a number of lines during the occurrences of the main characters. The analysis result may also be calculated by using words that are distinguished from the text content, especially names, occupations, positions, or nicknames used to refer to specific characters, and character relationships between main characters may be represented by using a number of conversation connections between the main characters. When referring to the drawing, character relationships may be represented by connecting lines when there is an interrelationship between the main characters, and the greater the strength of the relationship between the main characters, that is, the degree of interconnectedness, the thicker the lines connected to each other may be. The degree of interconnectedness may be calculated based on how often certain characters appear in a scene, how often an arbitrary character mentions other characters in a conversation, and the like.

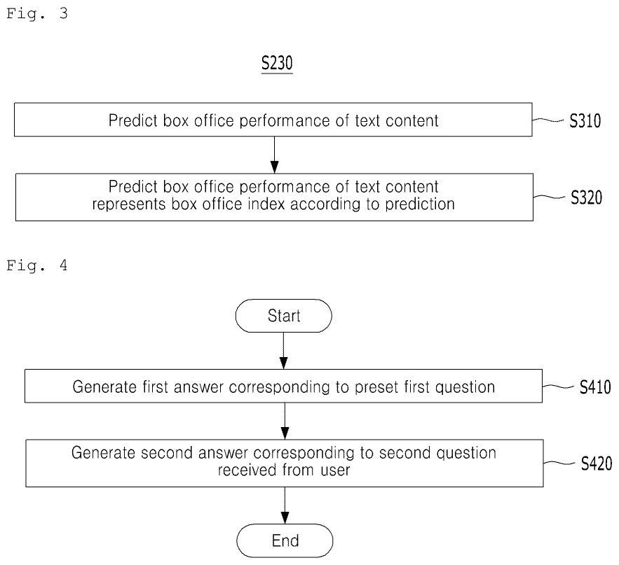

FIG. 3 is a flowchart showing steps of a method of generating a box office prediction result according to the present disclosure.

Referring to FIG. 3, a method of providing a box office prediction result in the method of generating the box office prediction result through the analysis of text content according to the present disclosure may first include predicting the box office performance of the text content based on the summary and the metadata analysis result (S310).

Here, when the text content is a drama, the box office performance may include an expected viewership rating or grade of the drama, and when the text content is a movie, the box office performance may include a return on investment (ROI). Here, the return on investment may be represented in the form of each country's currency (USD for the United States, KRW for Republic of Korea, etc.) and the ratio in percent (%) of profitability.

FIG. 8 is a diagram showing an example of an interface for selecting a viewership rating or grade in predicting the box office performance of a drama. For example, when the text content is about drama content, an interface may be provided to allow the user to select either the viewership rating or the grade in the interface shown in FIG. 8 so as to display a box office performance prediction. If the user selects a viewership rating and requests for a box office performance prediction, then the box office performance prediction result value may be displayed as an expected viewership rating. Meanwhile, the type of box office performance prediction result value displayed on the interface may automatically change depending on what type of content the previously input text content is for. For example, when the text content is determined to be related to movie content, an interface similar to FIG. 8 may display a selection of either ROI or number of viewers, or when the text content is determined to be related to a web novel, the interface may display a selection of either an expected number of views or an expected annual popularity ranking. In this way, user convenience may be enhanced by displaying different types of box office performance prediction result values displayed on the interface depending on what type of content the input text content is for.

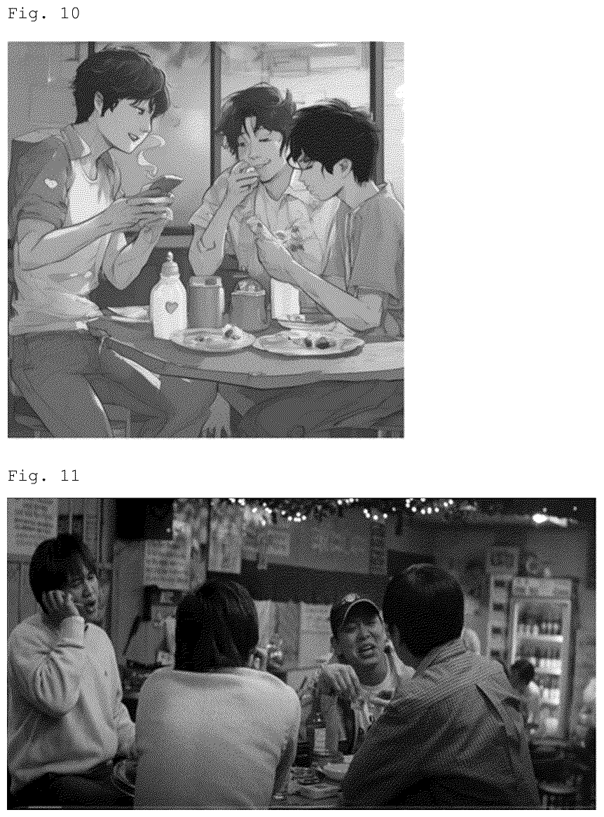

Subsequent to step S310, a step of generating a box office prediction result that qualitatively represents a box office index according to the prediction may be included (S320). In this step, the box office prediction result may be generated by qualitatively displaying the box office index using a graph form for preset box office elements. For example, FIG. 9 is a diagram showing an example of a box office index graph for text content. In FIG. 9, it can be seen that the preset box office elements include OTT suitability, global competitiveness, detailed description, fast-paced development, story empathy, story immersion, episode probability, and natural dialogue. Box office elements may not be limited to the above example, and may change at any time when generating a box office prediction result.

Referring again to FIG. 9, a score may be assigned to each box office element and displayed in the form of a bar graph using a result of analyzing the input text content. Here, the graph as shown in FIG. 9 may further provide an interface that allows the user to adjust the bar of a bar graph for each box office element, thereby allowing the user to change the score directly to simulate a degree of box office success when the score for each box office element is changed. When the user adjusts the bar of a bar graph to change the score for each box office element and then selects an update button, a box office performance prediction result to which the changed score is applied may be provided. For example, when the text content is a drama, an expected viewership rating to which the changed score is applied may be provided.

For reference, the present disclosure a serve as a debut platform for fledgling writers. That is, it may be possible to eliminate bias based on other people's personal tastes or preferences for the work of a writer who is completely unknown in the industry and predict box office performance through objective and fair evaluation. Through this, the works of new writers may be evaluated solely based on their works, just like famous writers, thereby increasing the probability that a fledgling writer's work will be produced, and serving as a debut platform for fledgling writers.

On the other hand, according to another embodiment of the present disclosure, box office performance may be predicted by inputting an early partial script or proposal data for the content. Specifically, when text content is received from the user, it may be implemented to receive an early partial script, such as a first episode script of a drama or a script of the beginning of a movie. Additionally, it may be implemented to receive proposal data centered on composition or plot.

Then, the present disclosure may be implemented to generate a box office prediction result based on the received early partial script or proposal data. For example, in the case of a drama, an initial box office prediction result, such as viewers' reactions at the beginning of the broadcast, may be generated. Furthermore, in the case of a movie, a prediction result, such as audience interest and immersion at the beginning of the movie, may be generated. This has an effect of generating and providing a prediction result that is helpful in investment/production decisions at an initial investment/production decision stage for content such as actual movie sand dramas.

Meanwhile, according to an embodiment of the present disclosure, a related image or video may be generated for the input text content. That is, in the present disclosure, when text content is received, a summary based on the received text content, meta information analysis, and box office performance prediction as well as a situation that can be derived from the text content may also be generated as a concept image or concept video and provided to the user.

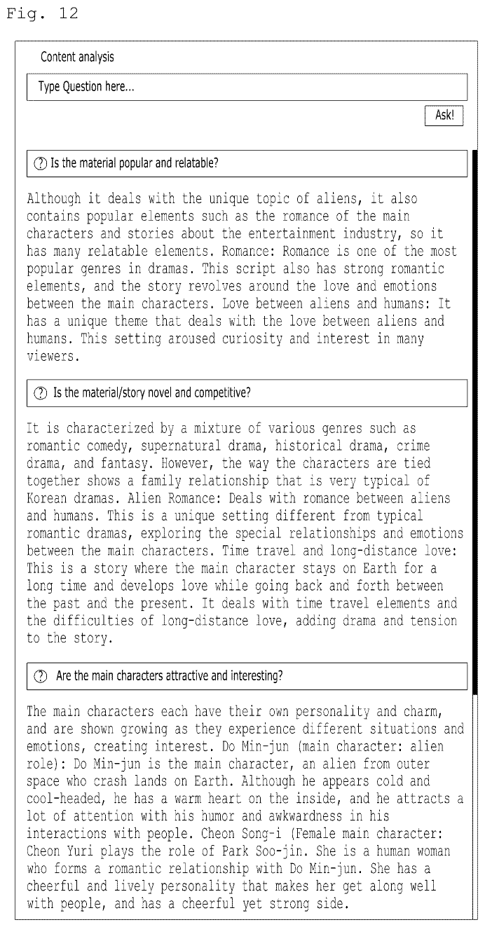

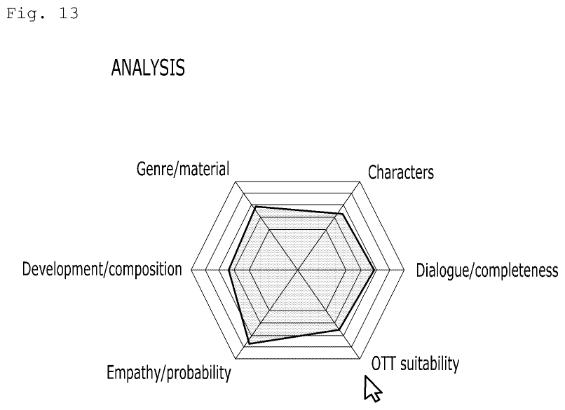

FIG. 10 is a diagram showing an example of a cartoon concept image generated for text content, and FIG. 11 is a diagram showing an example of a realistic image generated for text content.

Referring to FIGS. 10 and 11, a situation and a scene for given text within text content may be manually or automatically selected to generate a cartoon-concept image, a realistic image, or video and provide the generated image or video to the user.

For example, in case where the given text is “Gyeonwoo eats sundae to commemorate returning to school and chats with his friends. While drinking, Gyeonwoo sees a striking woman and thinks that she is his ideal type. Friends argue about why men can't stay calm when they see a pretty woman. At that moment, the cell phone rings and Gyeonwoo answers,” an image with a cartoon concept may be generated for the above situation and scene as shown in FIG. 10, and a realistic image may be generated and provided to the user as shown in FIG. 11. When such an image or video is generated, a plurality of pieces of information obtained from the text content, for example, a number of characters, a location where a scene is taking place, and a description of the character's appearance or behavior, may be referred thereto.

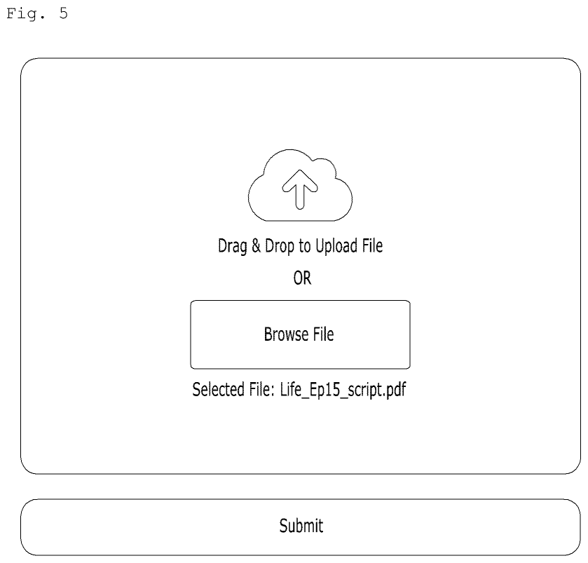

Meanwhile, FIG. 4 is a flowchart showing steps of a method of generating an answer to a question according to the present disclosure. Referring to FIG. 4, a method of providing a box office prediction result through the analysis of text content according to the present disclosure may be implemented to automatically provide, subsequent to generating the box office prediction result as described above with reference to FIG. 3, an answer to a question posed by the user based on the box office prediction result and information on the text content, and FIG. 4 shows a method of generating an answer to a user's question as described above.

Referring to FIG. 4, a method of generating an answer to a user's question may include first generating a first answer corresponding to a preset first question (S410), and then generating a second answer corresponding to a second question received from the user (S420). Here, the generating of a first answer corresponding to a first question may be implemented to generate information in advance that users may be curious about and answers to the information, and then output the prepared answers when an actual user asks a question about the relevant information. In the process of providing pre-generated answers, previously collected or newly generated graphs, designs, comparison tables, or other visual data may be provided together. Meanwhile, it may be understood that the generating of a second answer corresponding to a second question is generating, by a computing apparatus according to the present disclosure, when a user asks a question on information that has not been prepared in advance, a new answer to the user's question. The second answer corresponding to the second question may be generated based on a plurality of pieces of information collected by the computing apparatus from a network, and in this case, keywords included in the user's question may be used in the process of collecting information.

FIG. 12 is a diagram showing an example of a natural language question about text content and an answer thereto, wherein as shown in the diagram, a first answer to a first question related to a preset box office prediction result or information on the text content may be generated and provided to the user, and moreover, when the user inputs a second question that is different from the preset first question, a second answer may be generated and provided to the user.

Meanwhile, according to an embodiment of the present disclosure, the method of providing a box office prediction result through the analysis of text content may also include qualitatively displaying an analysis result for the text content using a radial graph form for preset items.

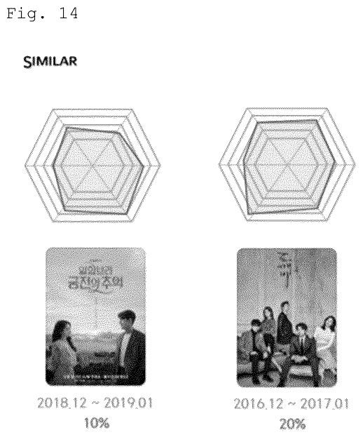

FIG. 13 is a diagram showing an example of a radial graph of an analysis result for text content, wherein, referring to FIG. 13, it can be seen that scores are assigned to characters, dialogue/completeness, OTT suitability, empathy/probability, development/composition, and genre/material items for text content, and the scores are represented as a hexagonal radial graph. In addition, a box office prediction result may be shown in addition to the analysis result shown in a radial graph, and FIG. 13 shows an expected viewership rating as a box office prediction result value when the text content is a drama.

Meanwhile, according to still another embodiment of the present disclosure, a method of providing a box office prediction result through the analysis of text content may search for and display works similar to the input text content from among previously published works using the items included in the radial graph in FIG. 13, and the genre and metadata of the text content.

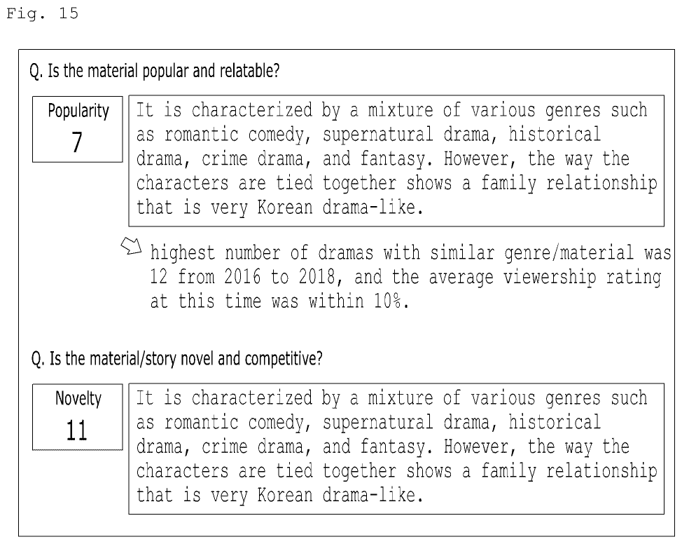

FIG. 14 shows an example of a search result for works similar to text content, wherein referring to FIG. 14, works similar to the input text content are searched, and representative images of the works, radial graphs of the analysis result for the works, airing or screening periods, and box office performances (viewership ratings for dramas, returns on investments (ROIs) for movies) may be displayed and provided to the user.

Meanwhile, according to yet still another embodiment of the present disclosure, a method of providing a box office prediction result through the analysis of text content may assign scores to items related to questions for preset questions related to the box office prediction result and information on text content.

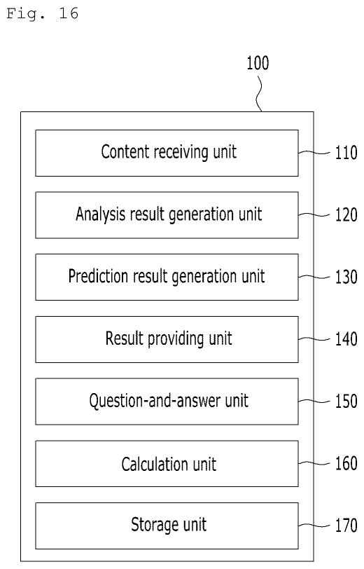

FIG. 15 is a diagram showing an example of scores assigned to questions about text content, wherein referring to the diagram, there can be seen an embodiment in which 7 points are assigned to a popularity item for the question “Is the material popular and relatable?” and 11 points are assigned to a novelty item for the question “Is the material/story novel and competitive?”. In this case, it may be possible to determine which item the question corresponds to and assign a score to that item using the analysis result of the text content. Meanwhile, at this time, it may be implemented such that a description of the reason for assigning that score is generated in a sentence and provided to the user. The user may have a doubt about the assigned score, and in order to minimize the user's doubt or distrust, a basis on which the score is assigned or a logic of the algorithm used to assign the score may be described in a series of sentences.

Additionally, the present disclosure may be implemented to extract existing similar works for the relevant item and provide an analysis thereof as well. In this process, past works with similar characteristics to the text content currently being analyzed may be retrieved, various types of records related to box office successes recorded by past works, and the environment (including social, economic, and policy environments) at the time when past works were commercialized may also be retrieved and provided to the user.

In the above, with reference to FIGS. 1 to 15, a method of providing a box office prediction result through the analysis of text content according to the present disclosure has been described.

Meanwhile, the foregoing description has been disclosed to focus on the situation of predicting, upon receiving text content, the box office success of content to be created based on the text content, and the text content-based analysis method process described above may be used in various fields as well.

For example, in an entertainment business field, when trying to produce video content such as dramas or movies, an analysis may be performed in advance to predict box office success based on text content, and then utilized to create a guide for enhancing a box office prediction result value, and the guide information created in this way may be suggested to production companies or production staffs in the form of opinions or provided as data, thereby being helpful in producing video content with a high probability of success.

For another example, in the field of developing a system that provides special effects in connection with the information of the content, it may be utilized to place special effects appropriate for the content when producing specific content or to suggest new types of special effects.

Hereinafter, an apparatus required to provide the method described above will be described. FIG. 16 shows detailed configurations of an apparatus that provides a box office prediction result through the analysis of text content according to the present disclosure.

Referring to FIG. 16, a box office prediction result providing apparatus 100 may include a content receiving unit 110, an analysis result generation unit 120, a prediction result generation unit 130, and a result providing unit 140.

The content receiving unit 110, which is configured to receive text content, may receive text content that requires a box office prediction from the user. Here, the text content may include at least one of a script, a scenario, and a proposal for content including a movie, a drama, novel, and a webtoon.

The analysis result generation unit 120, which is configured to analyze text content and generate an analysis result, may generate an analysis result through the analysis of the text content based on content information included in the text content input by the user.

The prediction result generation unit 130, which is configured to generate a box office prediction result for text content, may generate a box office prediction result for the text content based on the analysis result.

The result providing unit 140, which is configured to provide a box office prediction result, may provide the box office prediction result to the user.

According to an embodiment, when text content is received from the user, the content receiving unit 110 may receive information on the text content through direct typing from the user. Alternatively, the content receiving unit 110 may receive information on text content through a copy-and-paste operation rather than typing by the user. Alternatively, the content receiving unit 110 may receive a file corresponding to text content using a drag-and-drop method. Here, the file corresponding to the text content may include a text-based file with an extension of any one of txt, rtf, doc, docx, htm, html, json, xls, xlsx and pdf. For example, when the file corresponding to the text content has an extension such as docx, doc, htm, html, xlsx, or the like, the file may be internally converted into text. Furthermore, when the file corresponding to the text content is a pdf or image file, the text may be extracted and converted into text through optical character recognition (OCR).

FIG. 5 is a diagram showing an example of an interface for dragging and dropping a text content file. The user may input a file corresponding to text content into the interface using a drag-and-drop method. Through an interface for inputting a file using a drag-and-drop method, it may be possible to obtain an effect of allowing the user to easily input information on text content without inputting the information of the file through direct typing.

According to an embodiment, the analysis result generation unit 120 may generate a summary of content information included in the input text content.

FIG. 6 is a diagram showing an example of a summary of text content.

When the text content is a drama script, a summary may be generated through briefly summarizing the information of the drama script. Here, when summarizing the information of the script, a characters' dialogue may be excluded to generate a summary that describes characters, locations, relationships between characters, and the like so that the relevant scene can be drawn just by reading the summary.

Additionally, the analysis result generation unit 120 may analyze metadata information on the text content to generate a metadata analysis result. Here, the metadata information may include information of person information, genre information, location information, and conversation information between people included in information on the text content. In addition, the metadata analysis result may include a genre characteristic map, a number of scenes, a number of characters, a number of locations, a number of conversations, a number of scenes and lines for each main character, a character relationship between main characters for the text content. Further, the number of different scenes, dialogs, locations, settings-interior/exterior, day/night, etc. are used to produce the estimated cost of production in the pre-production stage. The number of dialogs per character is used to derive the cost for the contract with the corresponding actor or actress.

FIG. 7 is a diagram showing an example of a metadata analysis result.

The metadata analysis result may show a genre characteristic map. Depending on the characteristics of the input text content, scores may be assigned to respective representative genres, and the assigned scores may be connected to one another and displayed in the form of a radial graph. The user may easily identify the genre characteristics of the content by looking at the radial graph. In addition, the metadata analysis result may show a number of characters, a number of scenes, a number of locations, a number of characters' conversations that appear in the text content. Furthermore, the metadata analysis result may represent a number of scenes and a number of lines for each of the main characters. In addition, the number of dialogue connections between the main characters may be used to represent character relationships between the main characters. Here, the greater the strength of the relationship between the main characters, the thicker the lines connecting them may be.

According to an embodiment, the prediction result generation unit 130 may predict the box office performance of the text content based on the content analysis, the summary and the metadata analysis result.

Here, when the text content is a drama, the box office performance may include an expected viewership rating or grade of the drama, the number of views or votes/likes in digital formats (as in Youtube.com), the number of positive news and the number of negative news and their combinations, such as subtraction, social media responses including evaluative phrases or sentences or the emoticons such as a smiling face a thumbs-up, and a combination of all of these. Additionally, when the text content is a movie, the box office performance may include a return on investment (ROI) and similar metrics as in a drama. Here, the return on investment may be represented in the form of each country's currency (USD for the United States, KRW for Republic of Korea, etc.).

FIG. 8 is a diagram showing an example of an interface for selecting a viewership rating or grade in predicting the box office performance of a drama. For example, when the text content is a drama, the user may request for a box office performance prediction result value through selecting either viewership rating or grade in the interface shown in FIG. 8. When a viewership rating is selected and submitted, the expected viewership rating may be displayed.

In addition, the prediction result generation unit 130 may generate a box office prediction result that qualitatively represents a box office index according to the prediction. At this time, the prediction result generation unit 130 may generate the box office prediction result by qualitatively displaying the box office index using a graph form for preset box office elements.

FIG. 9 is a diagram showing an example of a box office index graph for text content. In FIG. 9, it is shown that the preset box office elements represent OTT suitability, global competitiveness, detailed description, fast-paced development, story empathy, story immersion, episode probability, and natural dialogue. Box office elements may not be limited to the above example, and may change at any time when generating a box office prediction result.

Referring again to FIG. 9, a score may be assigned to each box office element and displayed in the form of a bar graph using a result of analyzing the input text content. Here, the user may change the score through adjusting the bar of a bar graph for each box office element to simulate a degree of box office success when the score for each box office element is changed. When the user adjusts the bar of a bar graph to change the score for each box office element and then selects an update button, a box office performance prediction result to which the changed score is applied may be provided. When the text content is a drama, an expected viewership rating to which the changed score is applied may be provided.

According to an embodiment, the box office prediction result providing apparatus 100 may further include an image generation unit that generates a related image or video for the input text content. FIG. 10 is a diagram showing an example of a cartoon concept image generated for text content, and FIG. 11 is a diagram showing an example of a realistic image generated for text content.

Referring to FIGS. 10 and 11, a situation and a scene for given text within text content may be manually or automatically selected to generate a cartoon-concept image, a realistic image, or video and provide the generated image or video to the user. For example, in case where the given text is “Gyeonwoo eats sundae to commemorate returning to school and chats with his friends. While drinking, Gyeonwoo sees a striking woman and thinks that she is his ideal type. Friends argue about why men can't stay calm when they see a pretty woman. At that moment, the cell phone rings and Gyeonwoo answers,” an image with a cartoon concept may be generated for the above situation and scene as shown in FIG. 10, and a realistic image may be generated and provided to the user as shown in FIG. 11.

According to an embodiment, the box office prediction result providing apparatus 100 may further include a question-and-answer unit 150. Subsequent to generating the box office prediction result, the question-and-answer unit 150 may generate an answer corresponding to a preset question. FIG. 12 is a diagram showing an example of natural language questions about text content and answers thereto. As shown in FIG. 12, a first answer to a first question related to a preset box office prediction result or information on text content may be generated. In addition, when the user inputs a second question that is different from a preset first question, a second answer thereto may be generated, allowing real-time interaction.

According to an embodiment, the box office prediction result providing g apparatus 100 may qualitatively display an analysis result for text content using a radial graph for preset items. FIG. 13 is a diagram showing an example of a radial graph of an analysis result for text content. Referring to FIG. 13, scores are assigned to characters, dialogue/completeness, OTT suitability, empathy/probability, development/composition, and genre/material items for text content, and the scores are represented as a hexagonal radial graph. Additionally, a box office prediction result may be represented using an analysis result shown in a radial graph. FIG. 13 shows the expected viewership rating when the text content is a drama.

According to an embodiment, the box office prediction result providing apparatus 100 may search for and display works similar may the received text content from among previously published works using the items included in the radial graph in FIG. 13, and the genre and metadata of the text content. FIG. 14 is a diagram showing an example of a search result for works similar to text content. Referring to FIG. 14, works similar to the input text content are searched, and representative images of the works, radial graphs of the analysis result for the works, airing or screening periods, and box office performances (viewership ratings for dramas, returns on investments (ROIs) for movies) may be displayed and provided to the user.

According to an embodiment, the box office prediction result providing apparatus 100 may assign scores to items related to questions for preset questions related to a box office prediction result and information on text content. FIG. 15 is a diagram showing an example of scores assigned to questions about text content. Referring to FIG. 15, 7 points are assigned to a popularity item for the question “Is the material popular and relatable?” and 11 points are assigned to a novelty item for the question “Is the material/story novel and competitive?” In this case, it may be possible to determine which item the question corresponds to and assign a score to that item using the analysis result of the text content. At this time, a description of the reason for assigning that score may be generated in a sentence and provided to the user. Additionally, existing similar works for the relevant item may be extracted and an analysis thereof may be provided as well.

Lastly, the calculation unit 160, which is a subject that executes and controls tasks performed by the preceding configurations of the box office prediction result providing apparatus 100, may actually correspond to a central processing unit. The central processing unit may also be referred to as a controller, a microcontroller, a microprocessor, a microcomputer, or the like. Furthermore, the central processing unit may be implemented by hardware or firmware, software, or a combination thereof, and configured to include an application specific integrated circuit (ASIC) or a digital signal processor (DSP), a digital signal processing device (DSPD), a programmable logic device (PLD), or a field programmable gate array (FPGA) when implemented using hardware, and configured with firmware or software to include a module, a procedure, a function or the like that performs the foregoing functions or operations when implemented using firmware or software. In addition, the box office performance prediction result providing device 100 may of course include a storage unit 170, wherein the memory may be implemented as Read Only Memory (ROM), Random Access Memory (RAM), Erasable Programmable Read Only Memory (EPROM), Electrically Erasable Programmable Read-Only Memory (EEPROM), flash memory, Static RAM (SRAM), a hard disk drive (HDD), a solid-state drive (SSD) or the like.

In the above, a method and apparatus of providing a box office prediction result through the analysis of text content according to the present disclosure has been described. Meanwhile, the present disclosure is not limited to the foregoing specific embodiments and application examples, it will be of course understood by those skilled in the art that various modifications may be made without departing from the gist of the present disclosure as defined in the following claims, and it is to be noted that those modifications should not be understood individually from the technical concept and prospect of the present disclosure.

In particular, configurations that implement the technical features of the present disclosure included in the block diagrams and flowcharts shown in the drawings attached to this specification represent logical boundaries between the configurations. However, according to an embodiment of software or hardware, the shown configurations and functions thereof are executed in the form of stand-alone software modules, monolithic software structures, codes, services, and combinations thereof, and the functions may be implemented by being stored in a medium executable on a computer provided with a processor capable of executing the stored program codes, instructions, and the like, and therefore, all of these embodiments should also be regarded as falling within the scope of the present disclosure.

Accordingly, the accompanying drawings and technologies thereof describe the technical characteristics of the present disclosure, but should not be simply inferred unless a specific array of software for implementing such technical characteristics is clearly described otherwise. That is, the aforementioned various embodiments may be present, and may be partially modified while having the same technical features as those of the present disclosure, and thus such modified embodiments should also be regarded as falling within the scope of the present disclosure.

Furthermore, the flowchart describes operations in the drawing in a specific sequence, but has been shown to obtain the most preferred result, and it should not be understood that such operations must be carried out in the specific sequence or sequential sequence shown, or that all shown operations must be carried out. In a specific case, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed is:

1. A method of analyzing text content to provide a box office prediction result, the method comprising:
receiving text content from a user;
generating, based on content information included in the text content, an analysis result through the analysis of the text content;
generating, based on the analysis result, a box office prediction result for the text content; and
providing the box office prediction result to the user.

2. The method of claim 1, wherein the text content comprises at least one of a script, a scenario, and a proposal for content including a movie, a drama, a novel, and a webtoon.

3. The method of claim 2, wherein the receiving of the text content comprises:
receiving information on the text content through direct typing from the user; or
receiving information on the text content through a copy-and-paste operation; or
receiving a file corresponding to the text content using a drag-and-drop method.

4. The method of claim 3, wherein the file corresponding to the text content is a text-based file with an extension of any one of txt, rtf, doc, docx, htm, html, json, xls, xlsx, and pdf.

5. The method of claim 4, wherein the generating of the analysis result comprises:
generating a summary of content information included in the received text content; and
analyzing metadata information on the text content to generate a metadata analysis result.

6. The method of claim 5, wherein the metadata information comprises at least one of person information, genre information, location information, or conversation information between people included in information on the text content, and
wherein the metadata analysis result comprises at least one of a genre characteristic map, a number of scenes, a number of characters, a number of locations, a number of conversations, a number of scenes and lines for each main character, estimated cost of production, or a character relationship between main characters for the text content.

7. The method of claim 6, wherein the generating of the box office prediction result comprises:
predicting box office performance of the text content based on the content analysis, the summary and the metadata analysis result; and
generating a box office prediction result that qualitatively represents a box office index according to the prediction.

8. The method of claim 7, wherein when the text content is a drama, the box office performance comprises an expected viewership rating or grade of the drama, the number of views or votes/likes in digital formats, the number of positive news and the number of negative news and their combinations, such as subtraction, social media responses including evaluative phrases or sentences or the emoticons such as a smiling face a thumbs-up, and a combination of all of these, and
wherein when the text content is a movie, the box office performance comprises a return on investment (ROI).

9. The method of claim 8, wherein the generating of the box office prediction result comprises:
qualitatively displaying the box office index using a graph form for preset box office elements to generate the box office prediction result.

10. The method of claim 9, further comprising:
subsequent to generating the box office prediction result,
generating a first answer corresponding to a preset first question based on the box office prediction result and information on the text content; and
generating a second answer corresponding to a second question received from the user.

11. An apparatus of analyzing text content to provide a box office prediction result, the apparatus comprising:
a content receiving unit that receives text content;
an analysis result generation unit that generates an analysis result for text content;
a prediction result generation unit that generates a box office prediction result for text content; and
a result providing unit that provides a box office prediction result to a user.

12. The apparatus of claim 11, wherein the content receiving unit receives text content from a user,
wherein the analysis result generation unit generates, based on content information included in the text content, an analysis result through the analysis of the text content,
wherein the prediction result generation unit generates, based on the analysis result, a box office prediction result for the text content, and
wherein the result providing unit provides the box office prediction result to the user.

13. The apparatus of claim 12, further comprising:
a question-and-answer unit that generates, subsequent to generating the box office prediction result, an answer corresponding to a preset question, or an answer corresponding to a user's question different from the preset question.

14. A system comprising,
a memory in which at least one program is recorded; and
a processor that executes the program, the program comprising:
receiving text content from a user;
generating, based on content information included in the text content, an analysis result through the analysis of the text content;
generating, based on the analysis result, a box office prediction result for the text content; and
providing the box office prediction result to the user.
